(19) United States
(12) Patent Application Publication
(10) Pub. No.: US 2026/0037315 A1
(43) Pub. Date: Feb. 5, 2026

(54) AI ACCELERATOR, SoC AND ELECTRIC DEVICE INCLUDING AI ACCELERATOR, AND OPERATING METHOD OF AI ACCELERATOR

(71) Applicant: Gwanak Analog Co., Ltd., Seoul (KR)

(72) Inventors: Seongok BAE, Seoul (KR); Kyoungwon LIM, Seoul (KR); Kyuseok KIM, Seoul (KR)

(73) Assignee: Gwanak Analog Co., Ltd., Seoul (KR)

(21) Appl. No.: 19/092,507

(22) Filed: Mar. 27, 2025

(30) Foreign Application Priority Data
Aug. 5, 2024 (KR) 10-2024-0104056

(51) Int. Cl. G06F 9/50; G06F 9/54; G06F 15/80

(52) U.S. Cl. CPC G06F 9/5027; G06F 9/544; G06F 15/8061; G06F 2209/543

(57) ABSTRACT

Provided are an artificial intelligence (AI) accelerator, a system-on-chip (SoC) and electronic device including the AI accelerator, and an operating method of the AI accelerator. The AI accelerator includes a vector processing circuit (VPC) configured to, according to commands, perform a rearrangement on input data into sub-blocks, configured to generate addresses for the rearranged sub-blocks, and configured to perform vector processing for a convolution computation.

### CROSS-REFERENCE TO RELATED APPLICATIONS

This application claims the benefit of Korean Patent Application No. 10-2024-0104056, filed on Aug. 5, 2024, in the Korean Intellectual Property Office, the entire disclosure of which is incorporated herein by reference for all purposes.

### BACKGROUND

### 1. Field of the Invention

One or more embodiments relate to an artificial intelligence (AI) accelerator for speech processing, a system-on-chip (SoC) and electronic device including the AI accelerator, and an operating method of the AI accelerator.

### 2. Description of the Related Art

A convolutional neural network (CNN) may be used to obtain high performance in speech signal processing, such as speech recognition or speech synthesis. Since speech data has a one-dimensional (1D) data structure, a 1D convolution computation may be performed to process the speech data.

Unlike image data, which is generally processed in a CNN, speech data and/or weight data have high precision, so a floating-point data format is required and may not include zeros. Therefore, it is difficult to apply a method of reducing computations by finding and skipping zeros included in speech data or weight data.

### SUMMARY

According to an embodiment, in a one-dimensional (1D) neural network accelerator for speech signal processing, an unnecessary computation due to zeros added when applying a stride and/or a dilation rate may be efficiently removed.

According to an embodiment, in a structure of a complex calculator that uses a floating-point format, zeros generated by applying a stride and/or a dilation rate may be effectively removed by partitioning data into sub-blocks and generating an address to access the partitioned sub-blocks.

According to an aspect, there is provided an artificial intelligence (AI) accelerator including a vector processing circuit (VPC) configured to, according to commands, perform a rearrangement on input data into sub-blocks, configured to generate addresses for the rearranged sub-blocks, and configured to perform vector processing for a convolution computation

The commands may include at least one of a first command to perform the rearrangement on the input data into the sub-blocks and a second command to perform the convolution computation on the rearranged sub-blocks.

The VPC may include at least one of a command register configured to store a command for the vector processing transmitted from a central processing unit (CPU) core, an address controller configured to generate an address to access a buffer in which the input data and weight data are stored, a controller configured to generate control signals to control the VPC by decoding the command stored in the command register, an interconnect exchange (IX) buffer including a data buffer that stores the input data and a weight buffer that stores the weight data, a data aligner configured to select, from the input data and the weight data stored in the IX buffer, at least some input data and at least some weight data used for the convolution computation and configured to rearrange positions of the at least some input data and the at least some weight data according to computation units, and a vector computation circuit including the computation units for real-time processing of a speech signal and configured to perform the convolution computation on the rearranged sub-blocks.

The data aligner may include at least one of, to perform the rearrangement on the at least some input data according to a first command or to compute two vector operands according to a second command, a first data aligner configured to perform the rearrangement on the at least some input data corresponding to a first vector operand among the two vector operands, and to compute the two vector operands according to the second command, a second data aligner configured to perform the rearrangement on at least one of the at least some weight data and the at least some input data, which corresponds to a second vector operand among the two vector operands.

The first data aligner may include at least one of, according to the second command that uses the two vector operands, a first input register configured to store second 128-word data among two pieces of 128-word data to rearrange the first vector operand according to inputs of the computation units, a second input register configured to store 128-word data to rearrange the at least some input data according to the first command, and according to the second command, configured to store first 128-word data among the two pieces of 128-word data to rearrange the first vector operand according to the inputs of the computation units, for a mask generation, a mask generation circuit configured to generate first mask data used as a write enable write_enable control signal in a word unit with respect to an output memory or second mask data, a shifter configured to align pieces of data stored in the second input register according to the first command and configured to align pieces of data stored in each of the first input register and the second input register according to the second command, a masking circuit configured to generate data used for a multiplication and accumulation (MAC) computation through masking between the pieces of data aligned by the shifter and the second mask data and configured to record ‘0’ in a position of data that is not used for the MAC computation, and a mask register configured to store the first mask data.

The second data aligner may include a first input register and a second input register configured to respectively store two pieces of 128-word data to align the at least some weight data or the at least some input data corresponding to the second vector operand among the two vector operands, a shifter configured to align pieces of data stored in the first input register and the second input register, a mask generation circuit configured to generate mask data for a mask generation, and a masking circuit configured to generate data used for a MAC computation by masking the aligned pieces of data by the mask data.

The computation units may include at least one of 128 16-bit floating-point multipliers, 128 32-bit floating-point adders to obtain a sum of outputs of the 128 16-bit floating-point multipliers, an accumulator to obtain an accumulated sum of MAC computation results, and 128 rectified linear units (ReLUs) or 128 Leaky ReLUs.

The AI accelerator may further include a floating-point calculating circuit configured to perform a high-precision computation used in executing an application program.

According to another aspect, there is provided a system-on-chip (SoC) including a memory configured to store input data of an artificial neural network model for a convolution computation, a CPU core configured to generate commands for the convolution computation, a negative AND (NAND) controller configured to communicate with an external memory that stores weight data of the artificial neural network model for the convolution computation, and an AI accelerator configured to perform a rearrangement on the input data, which is obtained from the memory, into sub-blocks according to the commands and configured to perform the convolution computation by generating addresses for the rearranged sub-blocks, in which the commands include a first command configured to perform the rearrangement on the input data into the sub-blocks and a second command configured to perform the convolution computation on the rearranged sub-blocks.

The memory may be configured to further store at least one of information used by the CPU core to generate the commands for the AI accelerator and data to be transmitted to the AI accelerator. The CPU core may be configured to generate and transmit the commands that perform vector processing for the convolution computation performed by the AI accelerator.

The NAND controller may be configured to read the weight data stored in the external memory and transmit the weight data to a weight buffer of the AI accelerator.

The external memory may include a non-volatile memory including a NAND flash memory, in which the NAND flash memory may be connected to the SoC and configured to store at least one of the weight data and an instruction of the artificial neural network model.

The AI accelerator may include, according to the first command, a data aligner configured to select, from the input data, at least some input data used for the convolution computation and configured to perform a rearrangement on the selected at least some input data into the sub-blocks and a vector computation circuit including computation units, and according to the second command, configured to read the rearranged sub-blocks and configured to perform the convolution computation.

According to still another aspect, there is an electronic device including an SoC and a NAND flash memory connected to the SoC and configured to store weight data and an instruction of an artificial neural network model, in which the SoC includes a memory configured to store input data of the artificial neural network model for a convolution computation, a CPU core configured to generate commands for the convolution computation, a NAND controller configured to communicate with an external memory that stores the weight data of the artificial neural network model for the convolution computation, and an AI accelerator configured to perform a rearrangement on the input data, which is obtained from the memory, into sub-blocks according to the commands and configured to perform the convolution computation by generating addresses for the rearranged sub-blocks, in which the commands include a first command configured to perform the rearrangement on the input data into the sub-blocks and a second command configured to perform the convolution computation on the rearranged sub-blocks.

According to still another aspect, there is an operating method of an AI accelerator including storing input data and weight data in a buffer, storing a command transmitted from a CPU core, generating an address to access the buffer in which the input data and the weight data are stored, generating control signals by decoding the command, selecting, from the input data and the weight data stored in the buffer, at least some input data and at least some weight data used for a convolution computation, and performing the convolution computation by rearranging positions of the selected at least some input data and the selected at least some weight data according to computation units.

The command may include at least one of a storage position of the input data, a storage position of the weight data, a type of the convolution computation, a length of data involved in the convolution computation, a stride interval for the convolution computation, and a dilation rate.

The performing of the convolution computation may include, when pieces of information included in the command instruct performance of a dilated convolution computation, performing the dilated convolution computation, and when the pieces of information included in the command instruct performance of a transposed convolution computation, performing the transposed convolution computation.

The performing of the dilated convolution computation may include receiving, from the CPU core, a first partition command configured to partition the input data into multiple sub-blocks when a dilation rate among the pieces of information included in the command is greater than a preset value, accessing the input data in a data buffer using a storage position of the input data included in the command on the data buffer and length information of the input data, performing a rearrangement on the accessed input data into the multiple sub-blocks by the dilation rate according to the first partition command, according to position information of an output buffer included in the command, storing, in the output buffer, the accessed input data that is rearranged into the multiple sub-blocks, and performing the dilated convolution computation by sequentially accessing the rearranged multiple sub-blocks as the rearrangement of the accessed input data into the multiple sub-blocks is terminated.

The performing of the transposed convolution computation may include transposing the weight data, dividing the transposed weight data into sub-blocks and storing the divided sub-blocks in an external memory, performing the transposed convolution computation between the transposed weight data that is divided into the sub-blocks and the input data from which zeros to be added at a stride interval are removed, and storing a result of the transposed convolution computation in a data memory according to storage position information provided by the command.

Additional aspects of embodiments will be set forth in part in the description which follows and, in part, will be apparent from the description, or may be learned by practice of the disclosure.

According to embodiments, in a one-dimensional (1D) neural network accelerator for speech signal processing, an unnecessary computation due to zeros added when applying a stride and/or a dilation rate may be efficiently removed.

According to embodiments, in a structure of a complex calculator that uses a floating-point format, zeros generated by applying a stride and/or a dilation rate may be effectively removed by partitioning data into sub-blocks and generating an address to access the partitioned sub-blocks.

According to embodiments, in a 1D neural network accelerator for speech signal processing, an unnecessary computation due to zeros added when applying a stride and/or a dilation rate may be efficiently removed, thereby shortening the execution time of neural network layers and reducing power consumption.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an overview of a one-dimensional (1D) convolution computation used in speech signal processing, according to an embodiment;

FIG. 2 is a block diagram illustrating an artificial intelligence (AI) accelerator for speech signal processing, according to an embodiment;

FIG. 3 is a diagram illustrating a structure of a system-on-chip (SoC) and electronic device including an AI accelerator, according to an embodiment;

FIG. 4A is a diagram illustrating an example of a vector command for a vector processing unit, according to an embodiment;

FIG. 4B is a diagram illustrating an example of a register used in a vector processing unit, according to an embodiment;

FIGS. 5A and 5B are diagrams illustrating a structure of a data aligner, according to an embodiment;

FIG. 6 is a diagram illustrating a structure of a vector computation circuit that performs a multiplication and accumulation (MAC) computation, according to an embodiment;

FIG. 7A is a diagram illustrating a concept of a 1D dilated convolution computation, according to an embodiment;

FIG. 7B is a diagram illustrating a memory data alignment state before and after executing a VP_CONV1D_ALIGN command, according to an embodiment;

FIG. 7C is a diagram illustrating a process in which a data aligner aligns data to generate a sub-block sub-block0, according to an embodiment;

FIG. 7D is a diagram illustrating an operation of a data aligner in a process in which a data aligner generates a sub-block sub-block1, according to an embodiment;

FIG. 8 is a diagram illustrating a method in which an AI accelerator performs a dilated convolution computation, according to an embodiment;

FIG. 9 is a diagram illustrating a concept of a transposed convolution computation, according to an embodiment;

FIG. 10 is a diagram illustrating a method of removing zeros applied due to a stride when converting a transposed convolution computation with the stride applied to a general convolution computation and performing a computation, according to an embodiment;

FIG. 11 is a diagram illustrating a method of removing zeros in a transposed convolution computation, according to an embodiment;

FIG. 12 is a diagram illustrating a method of calculating addresses of a lk variable and weight data, according to an embodiment; and

FIG. 13 is a flowchart illustrating an operating method of an AI accelerator, according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

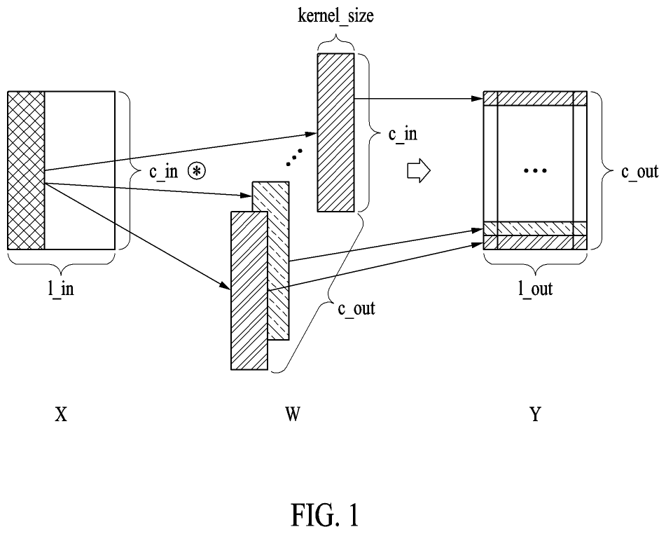

FIG. 1 is a diagram illustrating an overview of a one-dimensional (1D) convolution computation used in speech signal processing, according to an embodiment. FIG. 1 illustrates a diagram showing input data X, weight data W, and output data Y.

In an artificial intelligence (AI) computation, a convolution computation may be repeatedly performed to find a feature of the input data X. Since data of a speech signal changes along the time axis, a 1D convolution computation may be used when processing the speech signal.

For example, the length of the input data X may be defined as (l_in*c_in). The length of the output data Y may be defined as (l_out*c_out). The length of the weight data W may be defined as (c_in*kernel_size)*c_out matrices.

The output data Y may be generated by the dot product of a kernel and the input data X, that is, a convolution computation.

The following number of multiplication and accumulation (MAC) computations may be required to obtain one piece of output data Y. The MAC computation may be formed of multiplication and addition, and the number of MAC computations that must be performed to produce one piece of output data Y may be (c_in*kernel_size). Accordingly, the number of MAC computations that must be performed to calculate the entire output data Y may be (c_in*kernel_size)*l_out*c_out.

As described above, a large number of MAC computations may be performed to perform a 1D convolution computation. When the 1D convolution computation is performed in a general-purpose central processing unit (CPU), power consumption may increase and the execution time may be long.

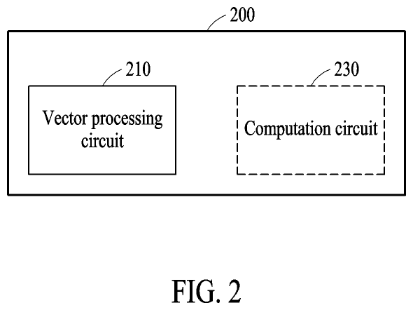

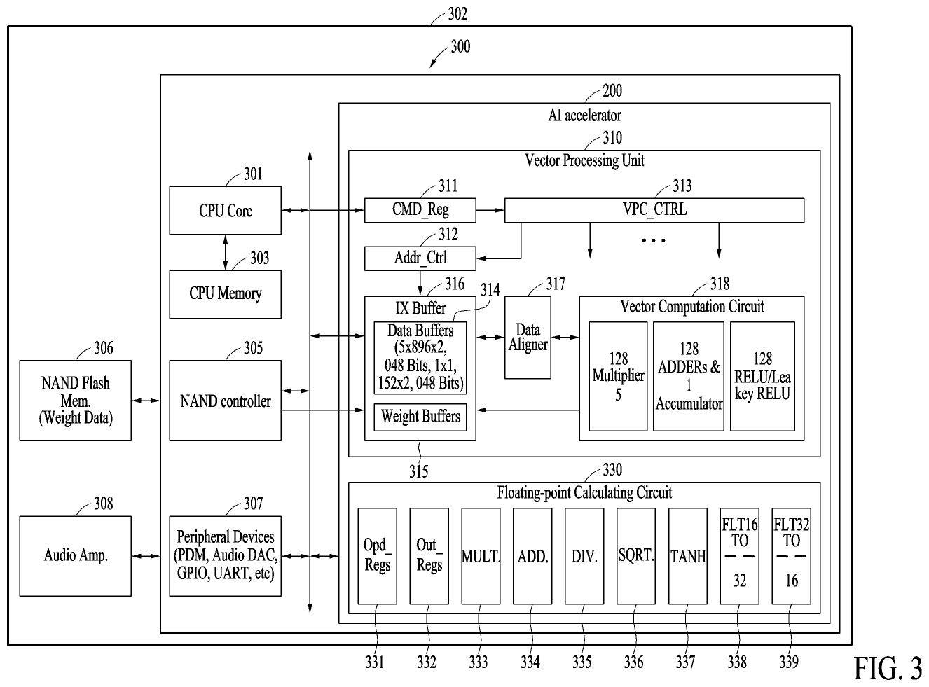

In an embodiment, using an AI accelerator (e.g., an AI accelerator 200) for speech signal processing, a convolution computation may be performed quickly and efficiently in an application, such as text-to-speech (TTS) or keyword spotting, which requires real-time processing. The structure of the AI accelerator is described in more detail below with reference to FIG. 2, and the structure of a system-on-chip (SoC) and electronic device including the AI accelerator is described in more detail below with reference to FIG. 3.

FIG. 2 is a block diagram illustrating an AI accelerator for speech signal processing, according to an embodiment. Referring to FIG. 2, according to an embodiment, the AI accelerator 200 may include a vector processing circuit (VPC) 210. In addition, the AI accelerator 200 may further include a computation circuit 230.

According to commands, the VPC 210 may rearrange input data into sub-blocks, generate addresses for the rearranged sub-blocks, and perform vector processing for a convolution computation. Here, weight data used for the convolution computation with the input data may be rearranged into the sub-blocks in advance and be stored in a negative AND (NAND) flash memory (e.g., a NAND flash memory 306 of FIG. 3).

Like a VPC 310 shown in FIG. 3, the VPC 210 may include, for example, a command register CMD_Reg 311, an address controller Addr_Ctrl 312, a VPC controller VPC_CTRL 313, an IX buffer 316, a data aligner 317, and a vector computation circuit 318, but embodiments are not necessarily limited thereto. The components of the VPC 210 are described in more detail below with reference to the VPC 310 of FIG. 3.

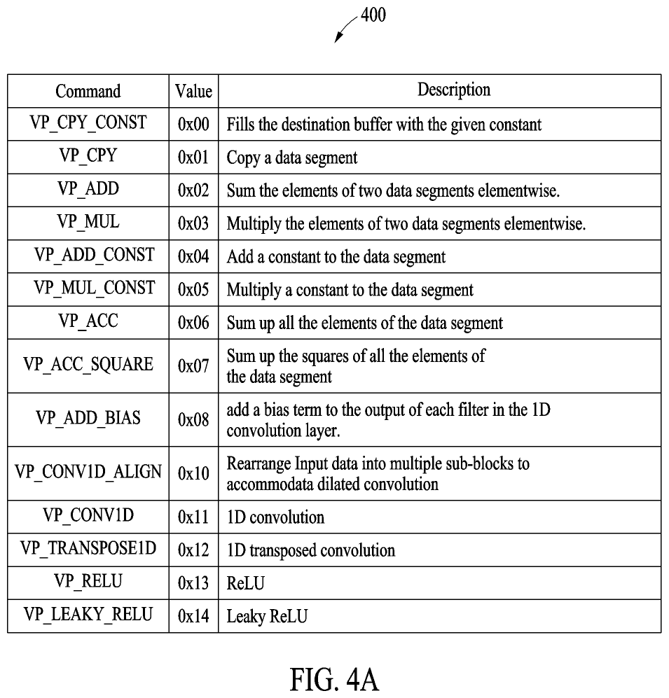

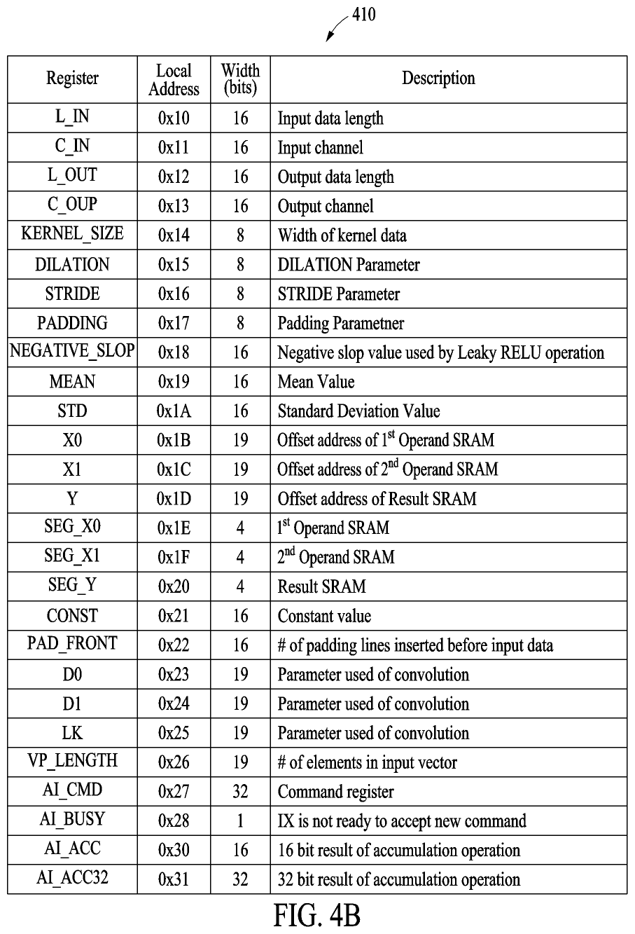

The commands may include, for example, at least one of a first command to rearrange the input data into the sub-blocks and a second command to perform a convolution computation on the rearranged sub-blocks. The commands may be received from a CPU core (e.g., a CPU core 301 of FIG. 3). The commands may be, for example, vector commands for a vector processing unit (e.g., the VPC 310 of FIG. 3) shown in FIG. 4A but are not necessarily limited thereto.

The computation circuit 230 may perform a general high-precision computation that is not directly related to the convolution computation. The computation circuit 230 may be, for example, a floating-point calculating circuit 330 that performs a high-precision computation used in performing an application program such as speech signal processing. The computation circuit 230 is described in more detail below with reference to the floating-point calculating circuit 330 of FIG. 3.

The AI accelerator 200 may set parameter(s) related to a vector computation and load a command for the vector computation to the command register CMD_Reg 311 to cause the vector computation circuit 318 including computation units to perform the vector computation. The AI accelerator 200 may perform a bit-parallel computation.

According to an embodiment, the AI accelerator 200 may be a hardware configuration that performs some functions of an SoC 300 or an electronic device 302 including the SoC 300, which is described below with reference to FIG. 3. Hereinafter, the AI accelerator 200 may be referred to as a hardware accelerator, an inference accelerator, and an IX, etc. The AI accelerator 200 may perform some functions of the electronic device 302 quicker than a software method implemented in a certain processor (e.g., a CPU). For example, the AI accelerator 200 may include at least one of a CPU, a graphics processing unit (GPU), a digital signal processor (DSP), an instruction set architecture (ISA), and a graphics card (or video card).

FIG. 3 is a diagram illustrating a structure of an SoC and electronic device including an AI accelerator, according to an embodiment. FIG. 3 illustrates a diagram showing a structure of the on-device SoC 300 including the AI accelerator 200 designed for speech signal processing and the electronic device 302 including the SoC 300, according to an embodiment.

The description provided with reference to FIG. 3 may also apply to FIG. 2. The configuration of the AI accelerator 200, the SoC 300, and/or the electronic device 302 shown in FIG. 3 is an example, and various modifications capable of implementing various embodiments disclosed herein are possible.

The SoC 300 may include the AI accelerator 200, a CPU core 301, a CPU memory 303, a NAND controller 305, and/or peripheral devices 307.

The AI accelerator 200 may be a hardware configuration that performs some functions of the SoC 300. The AI accelerator 200 may also be referred to as a hardware accelerator, an inference accelerator, an IX, etc. The AI accelerator 200 may perform some functions of the SoC 300 quicker than a software method implemented in a certain processor (e.g., a CPU). For example, the AI accelerator 200 may include at least one of a CPU, a GPU, a DSP, an ISA, and a graphics card (or video card).

The CPU core 301 may generate commands for the AI accelerator 200 (e.g., commands for vector processing performed by the AI accelerator 200) and transmit the commands to the AI accelerator 200.

The CPU memory 303 may store various pieces of information used in the CPU core 301. The CPU memory 303 may store at least one of input data of an artificial neural network model (or a vector computation circuit 318), information used by the CPU core 301 to generate the commands for the AI accelerator 200, and data to be transmitted to the AI accelerator 200. In the case of TTS, when character information is transmitted from the outside of the SoC 300, the SoC 300 may store the character information (input data of the AI accelerator 200) in the CPU memory 303 connected to the CPU core 301 and transmit the character information to the IX buffer 316 in the AI accelerator 200 at the necessary time. As described above, the CPU memory 303 may also be used as a temporary buffer that transmits data input from the outside of the SoC 300 to the IX buffer 316.

The NAND controller 305 may read data (e.g., weight data) stored in the NAND flash memory 306 outside the SoC 300 and transmit the data to weight buffers 315 of the AI accelerator 200. Here, the weight data may be stored in the NAND flash memory 306 after being rearranged in advance. The NAND flash memory 306 may be connected to the SoC 300 and may store weight data and/or an instruction of the artificial neural network model. Here, the instruction may correspond to, for example, an application program for speech signal processing. The application program may include TTS that converts text to speech or keyword spotting that recognizes keywords. When it is necessary to use the AI accelerator 200 while executing the application program, the application program may transmit the commands described above to the AI accelerator 200 and perform a necessary computation.

The peripheral devices 307 may transmit, to the AI accelerator 200, information received from the outside of the SoC 300 (e.g., a microelectromechanical system (MEMS) microphone connected to a pulse density modulation (PDM) device). The peripheral devices 307 may include, but are not necessarily limited thereto, for example, a PDM device, an audio digital-to-analog converter (DAC), a general-purpose input/output (GPIO), and a universal asynchronous receiver-transmitter (UART) that is a standard interface for asynchronous serial communication.

However, not all components illustrated in FIG. 3 are essential components. The SoC 300 may be implemented with more or less components than the components illustrated in FIG. 3.

The AI accelerator 200 may include the VPC 310 and the floating-point calculating circuit 330.

The VPC 310 may perform vector processing for various convolution computations, such as, for example, a dilated convolution computation and a transposed convolution computation. As described in more detail below, the dilated convolution computation may be performed by introducing another, such as parameter, a dilation rate, to a convolution layer. The dilation rate may represent the gap between kernels. The dilation rate may also be expressed as ‘dilation.’ The transposed convolution computation may be used when a general convolution computation is desired to be performed in reverse, and ‘0’ may be added between pieces of input data.

The VPC 310 may include, for example, the command register CMD_Reg 311, the address controller Addr_Ctrl 312, the VPC controller VPC_CTRL 313, the IX buffer 316, the data aligner 317, and the vector computation circuit 318 but is not necessarily limited thereto.

The command register CMD_Reg 311 may store a command for vector processing transmitted from the CPU core 301. An example of a command supported by the AI accelerator 200 is described in more detail below with reference to FIG. 4A. In addition, an example of registers used in the VPC 310 is described in more detail below with reference to FIG. 4B.

The address controller Addr_Ctrl 312 may generate an address to access the IX buffer 316 in which input data and/or weight data are stored. The address controller Addr_Ctrl 312 may generate an address to access the input data and the weight data stored in the IX buffer 316 and an address to store the result of the command execution according to a control signal generated from the VPC controller VPC_CTRL 313.

For example, when the command register CMD_Reg 311 receives the command transmitted from the CPU core 301, the VPC controller VPC_CTRL 313 may generate (create) control signals to control each component of the VPC 310 by decoding the command stored in the command register CMD_Reg 311. The VPC controller VPC_CTRL 313 may transmit the generated control signals to the address controller Addr_Ctrl 312 and/or the vector computation circuit 318.

The IX buffer 316 may store the input data and the weight data. The IX buffer 316 may include data buffers 314, which store the input data, and weight buffers 315, which store the weight data. The data buffers 314 may include buffers having a size of, for example, 5×384×2048 bits, 1×1 bits, or 152×2048 bits. The weight buffers 315 may include buffers having a size of, for example, 2×1 bits or 152×2048 bits. The IX buffer 316 may also be referred to as an ‘accelerator buffer.’

In the data buffers 314 and the weight buffers 315, for example, 128 words may be accessed simultaneously. Here, c_in that defines the length of the input data may not generally be a multiple of 128, and also, the start position on the data buffers 314 in which the input data is stored may be out of an integer multiple position of 128. Accordingly, to perform 128 MAC calculators simultaneously, the AI accelerator 200 may read two words, select 128 pieces of data used in the MAC computation among the two words, align the positions of the selected 128 pieces of data, and provide the aligned 128 pieces of data to computation units of the vector computation circuit 318.

The data aligner 317 may rearrange input data and/or weight data that are read from the IX buffer 316 to provide data required by the VPC controller VPC_CTRL 313 or the IX buffer 316.

The data aligner 317 may select input data and/or weight data required for a corresponding computation (e.g., a convolution computation) from the input data and the weight data stored in the IX buffer 316 and may align the position of the selected data (e.g., the input data and/or the weight data) according to the computation units of the vector computation circuit 318. The computation units may include, but are not limited thereto, at least one of 128 16-bit floating-point multipliers, 128 32-bit point adders to obtain the sum of outputs of the 128 16-bit floating-point multipliers, one accumulator to obtain an accumulated sum of MAC computation results, and 128 rectified linear units (ReLUs) or 128 Leaky ReLUs.

For example, according to a first command, the data aligner 317 may select, from the input data, at least some input data used for a convolution computation and rearrange the selected at least some input data into the sub-blocks.

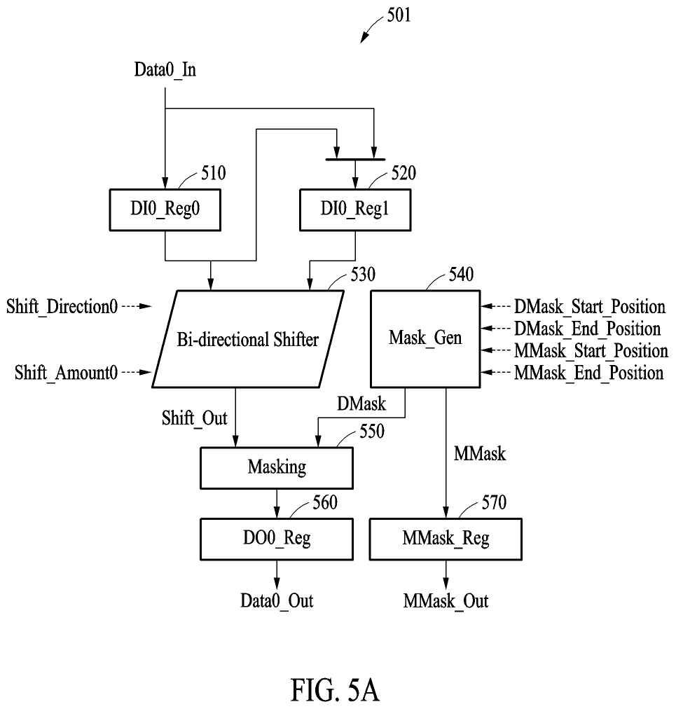

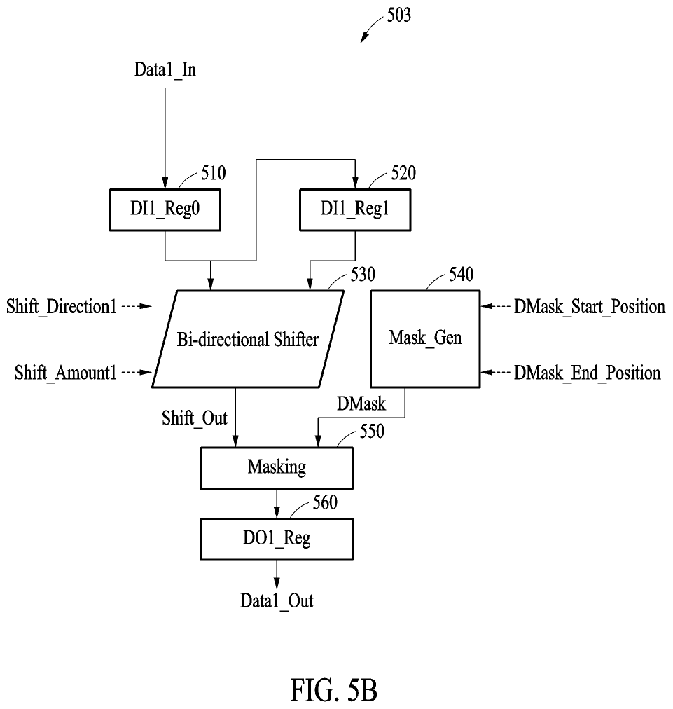

The data aligner 317 may include at least one of a first data aligner (e.g., a first data aligner 501 of FIG. 5A) and a second data aligner (e.g., a second data aligner 503 of FIG. 5B). The first data aligner may rearrange the at least some input data according to the first command to rearrange the input data into the sub-blocks. In addition, the first data aligner may rearrange data of a sub-block, which corresponds to a first vector operand of two vector operands, according to a second command to perform a convolution computation on the rearranged sub-blocks. Here, the first command may correspond to a command (e.g., conv1d_align) that performs data alignment to divide the input data into the sub-blocks and may use only a second input register. The second command may correspond to a command (e.g., conv1d) that performs the alignment to supply the input data that is rearranged into the sub-blocks to the computation units. The second command may use both a first input register and the second input register.

The AI accelerator 200 may rearrange the input data into the sub-blocks through a conv1d_align command and perform a computation on the sub-blocks according to the conv1d command.

For example, when the AI accelerator 200 performs vector multiplication and addition computations, the first data aligner may rearrange the input data that is the first vector operand. When the AI accelerator 200 performs a dilated convolution computation, the first data aligner may perform a rearrangement on the sub-blocks of the input data to rearrange the input data into the sub-blocks when executing the first command (e.g., conv1d_align) and may rearrange sub-block data when executing the second command. In addition, when the AI accelerator 200 performs a transposed convolution computation, the first data aligner may rearrange the input data.

The second data aligner may rearrange the at least some weight data corresponding to a second vector operand to compute two vector operands according to the second command to perform a convolution computation on the rearranged sub-blocks. Here, the second command may correspond to a command that performs the alignment to supply the weight data to the computation units.

For example, when the second command is Transposed1D, the first data aligner may perform the alignment to supply the input data to the computation units and may use both the first input register and the second input register.

In addition, the second data aligner may perform the alignment to supply, to the computation units, the weight data, which is divided into the sub-blocks in advance, stored in the NAND flash memory 306, and then read from the IX buffer 316, and may use both the first input register and the second input register.

The AI accelerator 200 may rearrange the weight data in advance and perform a computation by reading the rearranged weight data when executing the transpose1d command.

For example, when the AI accelerator 200 performs vector multiplication and addition computations, the second data aligner may rearrange the input data that is the second vector operand. Here, the vector multiplication and addition computations may require two vector operands. When the AI accelerator 200 performs a dilated convolution computation, the second data aligner may rearrange the weight data to the form required by the vector computation circuit 318 when executing the second command. In addition, when the AI accelerator 200 performs a transposed convolution computation, the second data aligner may rearrange the weight data that is rearranged into the sub-blocks.

The structure and operation of the first data aligner and the second data aligner to process the input data and the weight data are described in more detail below with reference to FIGS. 5A and 5B.

The vector computation circuit 318 may correspond to a computation block for real-time processing of a speech signal. The vector computation circuit 318 may include computation blocks (or computation units), such as, for example, 128 multipliers, 128 adders, 1 accumulator, and/or 128 ReLUs/Leaky ReLUs but is not necessarily limited thereto.

The vector computation circuit 318 may read, for example, the sub-blocks rearranged by the data aligner 317 according to the second command and may perform a convolution computation.

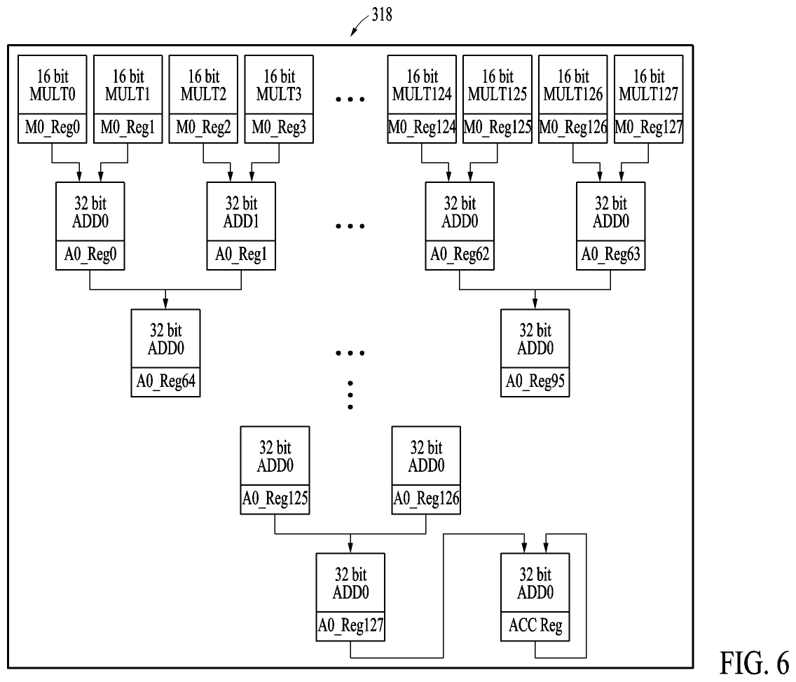

The vector computation circuit 318 may have a structure capable of performing 128 MAC computations in one clock cycle. The vector computation circuit 318 may use a 16-bit floating-point data format for high-precision speech signal processing. The hardware structure of the vector computation circuit 318 that performs the MAC computations is described in more detail below with reference to FIG. 6.

The floating-point calculating circuit 330 may not perform a computation that is directly related to a convolution computation but may perform a computation related to other vector commands. The floating-point calculating circuit 330 may perform a general high-precision computation used in performing an application program, such as, for example, speech signal processing.

The floating-point calculating circuit 330 may include, for example, an input register Opd_Regs 331 that stores the input data corresponding to an operand, an output register Out_Regs 332 that stores output data, a multiplication computation unit (MULT) 333 that performs a multiplication computation, an addition computation unit (ADD) 334 that performs an addition computation, a division computation unit (DIV) 335 that performs a division computation, a square root computation unit (SQRT) 336 that performs a square root computation, a Tanh computation unit (TANH) 337 that performs a Tanh computation, and conversion blocks in the floating-point format (e.g., an FLT16_TO_32 conversion block 338 and an FLT32_TO_16 conversion block 339) that converts the floating-point format of a computation result.

In the case of a floating-point computation, when the AI accelerator 200 stores the input data as an operand in the input register Opd_Regs 331, an output value may be stored in the output register Out_Regs 332 in the next cycle so that the CPU core 301 may read the output data from the output register Out_Regs 332 of the floating-point calculating circuit 330.

The electronic device 302 may include the SoC 300 and the NAND flash memory 306 described above. The NAND flash memory 306 may correspond to an example of a non-volatile memory, and various other non-volatile memories may be used in place of the NAND flash memory 306. The NAND flash memory 306 may be connected to the SoC 300 and may store the weight data and the instruction of the artificial neural network model.

In addition, the electronic device 302 may further include an audio amplifier Audio Amp 308. The audio amplifier Audio Amp 308 may communicate with the peripheral devices 307. The audio amplifier Audio Amp 308 may be used to amplify a speech signal when the speech signal generated from input characters in an application, such as TTS, is output to an external speaker. The speech signal output from an external microphone may be transmitted to the AI accelerator 200 through the PDM device, which is one of the peripheral devices 307, and this may be used in a keyword spotting application.

FIG. 4A is a diagram illustrating an example of a vector command for a vector processing unit, according to an embodiment, and FIG. 4B is a diagram illustrating an example of a register used in a vector processing unit, according to an embodiment.

The AI accelerator 200 may perform vector processing by commands transmitted from the CPU core 301. Here, an example of vector commands transmitted from the CPU core 301 to the AI accelerator 200 is as shown in a table 400 of FIG. 4A.

The vector commands are commands executed by a vector processing unit and may include commands such as VP_CPY_CONST, VP_CPY, VP_ADD, VP_MUL, VP_ADD_CONST, VP_MUL_CONST, VP_ACC, VP_ACC_SQUARE, VP_ADD_BIAS, VP CONV1D_ALIGN, VP_CONV1D, VP_TRANSPOSE1D, VP_RELU, and VP_LEAKY_RELU.

VP_CPY_CONST may correspond to a command to fill a destination buffer with a given constant. VP_CPY may correspond to a command to copy a data segment. VP_ADD may correspond to a command to add elements of two data segments elementwise. VP_MUL may correspond to a command to multiply elements of two data segments elementwise. VP_ADD_CONST may correspond to a command to add a constant to a data segment. VP_MUL_CONST may correspond to a command to multiply a data segment by a constant. VP_ACC may correspond to a command to sum up all elements of a data segment. VP_ACC_SQUARE may correspond to a command to sum up squares of all elements of a data segment. VP_ADD_BIAS may correspond to a command to add a bias term to each filter output of a 1D convolution layer. VP_CONV1D_ALIGN may correspond to a command to rearrange input data into multiple sub-blocks to accommodate a dilated convolution. In an embodiment, by introducing a command, VP_CONV1D_ALIGN, a dilated convolution computation may be efficiently performed by rearranging the input data into the multiple sub-blocks.

VP_CONV1D may correspond to a command to perform a 1D convolution. VP_TRANSPOSE1D may correspond to a command to perform a 1D transposed convolution. VP_RELU may correspond to a command to perform a computation according to a ReLU function. VP_LEAKY_RELU may correspond to a command to perform a computation according to a Leaky ReLU function.

The AI accelerator 200 may pre-load data used for a computation of the vector computation circuit 318 to the data buffers 314. In addition, the AI accelerator 200 may also store the computation result in the data buffers 314.

The AI accelerator 200 may set parameter(s) related to the vector computation, load a corresponding command to the command register CMD_Reg 311, and cause the vector computation circuit 318 to perform the vector computation. While the vector computation is being executed, the VPC controller VPC_CTRL 313 may maintain a busy flag value as ‘1.’

The number of local addresses and bits of each register, which is used in the vector computation circuit 318, may refer to a table 410 illustrated in FIG. 4B.

FIGS. 5A and 5B are diagrams illustrating a structure of a data aligner, according to an embodiment.

The data aligner Data_Aligner 317 may include two sub-blocks (e.g., a first data aligner Data_Aligner0 501 and a second data aligner Data_Aligner1 503) to align input data.

FIG. 5A illustrates a diagram showing the structure and operation of the first data aligner Data_Aligner0 501, according to an embodiment.

The first data aligner Data_Aligner0 501 may be driven when a command for rearranging data, such as a VP_CPY command or a VP_CONV1D_ALIGN command, is received. The first data aligner Data_Aligner0 501 may have a path that directly stores input data in an input register DI0_Reg0 to perform the command for rearranging data.

The first data aligner Data_Aligner0 501 may rearrange at least some input data according to a first command or rearrange at least some input data corresponding to a first vector operand among two vector operands to compute the two vector operands according to a second command.

The first data aligner Data_Aligner0 501 may include, for example, first and second input registers 510 and 520, a shifter 530, a mask generation circuit Mask_Gen 540, a masking circuit 550, an output register 560, and a mask register 570.

According to the second command that uses the two vector operands, the first input register 510 may store second 128-word data among two pieces of 128-word data to rearrange the first vector operand according to inputs of computation units.

The second input register 520 may store 128-word data to rearrange at least some input data according to the first command, and according to the second command, may store first 128-word data of the two pieces of 128-word data to rearrange the first vector operand according to the inputs of the computation units.

The shifter 530 may align input data received from the first and second input registers 510 and 520 and generate aligned data Shift_Out. The shifter 530 may be a bidirectional shift register capable of performing a shift operation bidirectionally but is not necessarily limited thereto. The shifter 530 may align the input data received from the first and second input registers 510 and 520 according to a signal that controls a shift direction Shift_Direction0 and a shift interval Shift Amount0.

The mask generation circuit Mask_Gen 540 may generate, for a mask generation, first mask data (e.g., MMask data) used as a write enable write_enable control signal in a word unit with respect to an output memory or second mask data (e.g., DMask data) used to select a valid input value for the vector computation circuit 318.

The masking circuit 550 may perform masking that makes data, which is not used for a computation, be “0” by using the shifter 530 and the second mask data DMask. The masking circuit 550 may generate data used for the vector computation, such as a MAC computation, through masking between the data Shift_Out aligned by the shifter 530 and the second mask data DMask and may generate masking data Data0_Out that records zeros (‘0’) in the position of the data that is not used for the vector computation.

The output register DO0_Reg 560 may store and/or output the masking data Data0_Out generated by the masking circuit 550.

The mask register 570 may store and/or output the first mask data MMask data generated by the mask generation circuit Mask_Gen 540. The mask register 570 may store the first mask data MMask data used as a write enable write_enable control signal in a word unit with respect to the output memory in which the computation result is stored.

The mask generation circuit Mask_Gen 540 may generate the second mask data DMask or the first mask data MMask data used as a write enable write_enable control signal in a word unit with respect to the output memory.

When a command that rearranges data is executed, the output register DO0_Reg 560 may store and/or output the masking data Data0_Out generated by the masking circuit 550. Here, the first mask data MMask data used as a write enable write_enable control signal in a word unit with respect to the output memory may have a mask value generated by a value (or an address) indicating a mask start position MMask_Start_Position and a mask end position MMask_End_Position.

For example, in the case of a command in which an AI accelerator performs a convolution computation, such as VP_CONV1D or VP_TRANSPOSE1D, in the computation result, one 16-bit word may be generated and the position to store the one 16-bit word in 128 words may be specified by the mask start position MMask_Start_Position and the mask end position MMask_End_Position. In the second mask DMask generated by the mask generation circuit Mask_Gen 540, only a bit at a certain position may have a value of “1,” and the remaining bit(s) may all have a value of “0.”

In addition, in the case of a command that performs a convolution computation, such as VP_CONVID or VP_TRANSPOSE1D, 128 words may be accessed simultaneously in each of the data buffers 314 and the weight buffers 315. The length of the input data c_in may generally not be a multiple of 128. Accordingly, to perform 128 MAC calculators simultaneously, the AI accelerator may respectively read two pieces of 128-word data of the input data and the weight data, select 128 pieces of data required for the MAC computation from among the two pieces of 128-word data, align the positions of the selected 128 pieces of data, and provide the 128 selected pieces of data to the computation units. In the case of the input data, the two pieces of 128-word data may be stored in a data register DI_Reg0 and a data register DI_Reg1, respectively.

The first data aligner Data_Aligner0 501 may align data using the shifter 530 and may then generate data required for the MAC computation through masking between the aligned data Shift_Out and the second mask data DMask.

For example, when the number of pieces of data required for a computation is less than 128, the mask generation circuit Mask_Gen 540 may generate a mask having a corresponding bit of “0” for data that is not used for the computation and may process the corresponding word to have a value of “0” while passing through the masking circuit 550. In this way, the data having a value of “0” may not have any effect on the MAC computation and the accumulation computation.

FIG. 5B illustrates a diagram showing the structure and operation of the second data aligner Data_Aligner1 503, according to an embodiment.

The second data aligner Data_Aligner1 503 may be used to align a second operand when two vector operands, such as, for example, a VP_ADD command, a VP_CONV1D command, or a VP_TRANSPOSED1D command, must be computed.

According to a second command, the second data aligner Data_Aligner1 503 may rearrange at least one of at least some weight data and at least some input data corresponding to the second vector operand among the two vector operands to compute the two vector operands.

The second data aligner Data_Aligner1 503 may include the first and second input registers 510 and 520, the shifter 530, the mask generation circuit Mask_Gen 540, the masking circuit 550, and the output register 560.

The first and second input registers 510 and 520 may store two pieces of 128-word data used to align the second operand, respectively.

The shifter 530 may align pieces of data stored in the first and second input registers 510 and 520. The shifter 530 may be a bidirectional shift register capable of performing a shift operation bidirectionally but is not necessarily limited thereto. The shifter 530 may align at least one of the input data and weight data received from the first and second input registers 510 and 520 according to a signal that controls a shift direction Shift_Direction1 and a shift interval Shift_Amount1.

The mask generation circuit Mask_Gen 540 may generate, for a mask generation, mask data (e.g., DMask data) used to select a valid input value for the vector computation circuit 318.

The masking circuit 550 may generate data used for a MAC computation by masking the data Shift_Out aligned by the shifter 530 with second mask data DMask data (DMask data) generated by the mask generation circuit Mask_Gen 540. Masking may be performed by the masking circuit 550.

The operating method of the second data aligner Data_Aligner1 503 may be the same as that of the first data aligner Data_Aligner0 501, and output data Data1_Out output from the output register DOI_Reg 560 of the second data aligner Data_Aligner1 503 may be transmitted to the vector computation circuit 318.

More specifically, the second data aligner Data_Aligner1 503 may store, for example, two pieces of 128-word data in the first input register D_Reg0 510 and the second input register D_Reg1 520, respectively. The second data aligner Data_Aligner1 503 may align the pieces of data stored in the first input register D_Reg0 510 and the second input register D_Reg1 520 using the shifter 530.

For example, when the number of pieces of data required for a computation is less than 128, in the data that is not used for the computation, a corresponding bit may be expressed as ‘0’ by the masking circuit 550. When the corresponding bit is expressed as ‘0,’ the corresponding word may be processed to have a value of ‘0’ while passing through the masking circuit 550. As described above, data having a value of ‘0’ may not have any effect on the MAC computation and the accumulation computation. Both the input data and the weight data may be processed by a hardware block (e.g., the data aligner 317) having the same structure.

FIG. 6 is a diagram illustrating a structure of a vector computation circuit that performs a MAC computation, according to an embodiment. According to an embodiment, FIG. 6 illustrates a hardware structure of the vector computation circuit 318 including computation units, which performs a MAC computation.

The vector computation circuit 318 is for real-time speech signal processing and may have a structure capable of processing, for example, 128 MAC computations simultaneously. The vector computation circuit 318 may include, for example, 128 16-bit floating-point multipliers (16 bit MULT0 to MULT127), 128 32-bit floating-point adders 32-bit ADD to obtain the sum of outputs of the 128 16-bit floating-point multipliers, and/or an accumulator ACC to calculate and store the accumulated sum of the 128 MAC computation results when the number of pieces of data for the MAC computation is greater than 128.

An output of each computation unit (e.g., a 16-bit floating-point multiplier, a multiplier, a 32-bit floating-point adder, and/or an accumulator) of the vector computation circuit 318 may be loaded to an output register. Data (a computation result) loaded to the output register may be processed in a pipeline manner and enable high-speed computation of an AI accelerator. The 128 32-bit floating-point adders used for the MAC computation may be configured in a tree shape and perform a computation that accumulates 128 results but may operate as 128 independent adders in the computation such as bias addition or vector addition.

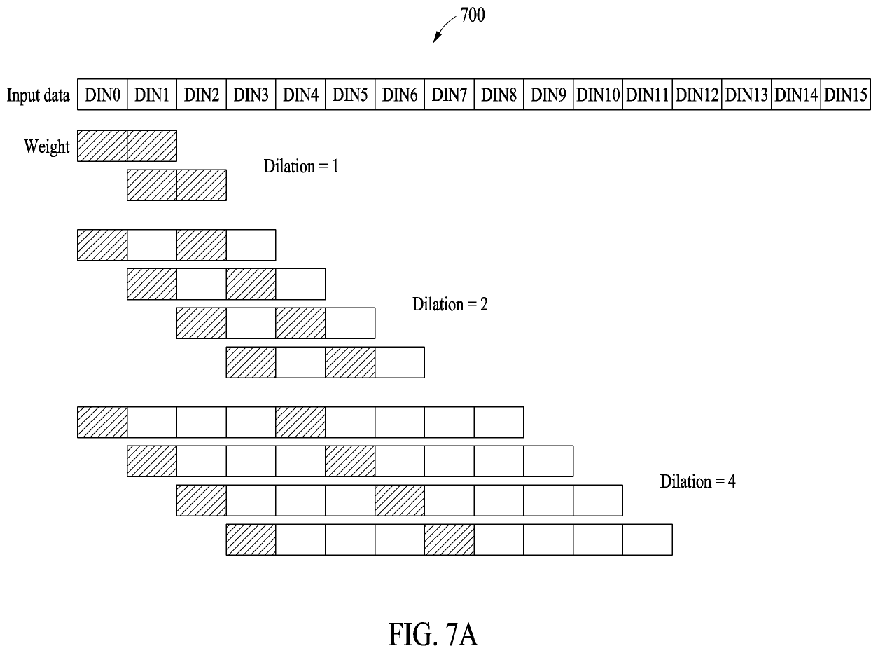

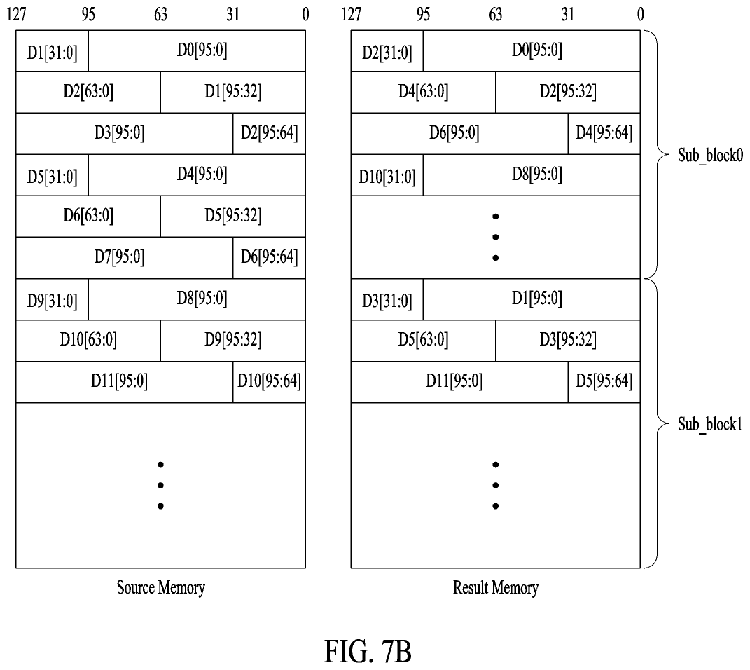

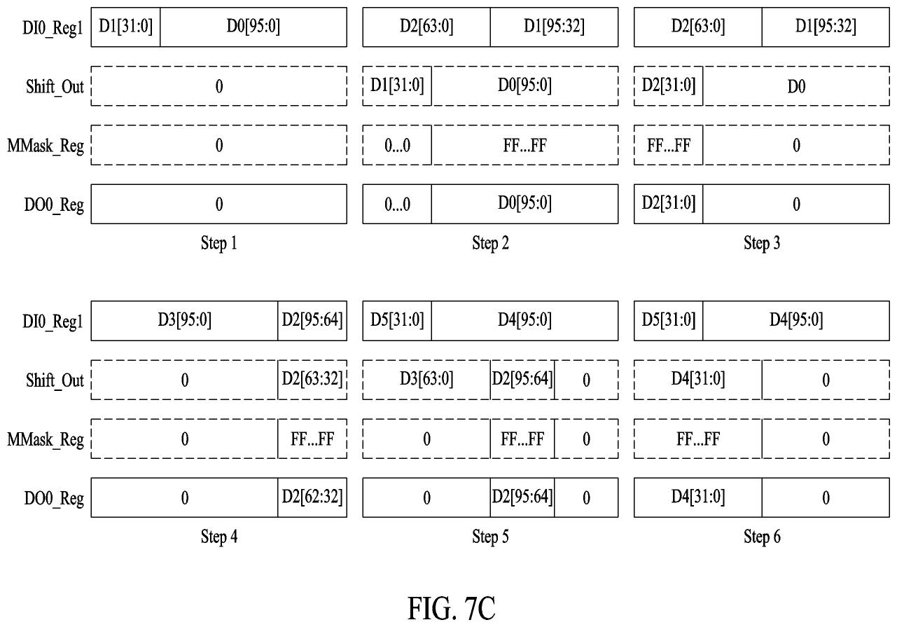

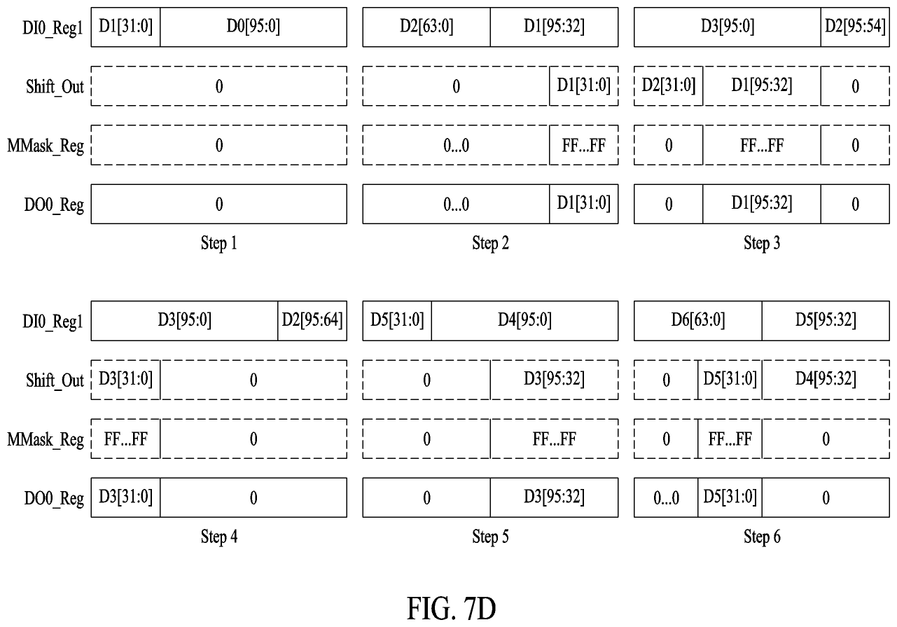

FIG. 7A is a diagram illustrating a concept of a 1D dilated convolution computation, according to an embodiment. FIG. 7A illustrates a diagram 700 showing a process of performing a 1D convolution computation by applying different dilation rates (e.g., dilation=1, 2, 4) to 16 pieces of input data (e.g., DIN0, DIN1, . . . , DIN15) and a weight having a kernel size kernel_size of 2 (i.e., kernel_size=2), according to an embodiment.

In the 1D convolution computation, an output may be calculated by performing a convolution computation by moving a weight horizontally with respect to the input data at an interval according to the different dilation rates. Here, the ‘dilation rate’ may refer to an interval between kernels, that is, how much interval between kernels (or weights) are to be applied. For example, when the dilation rate is 1 (i.e., dilation rate=1), a weight having a kernel size of 2(i.e., kernel size=2) may be applied without any change during a computation, and when the dilation rate is 2 (i.e., dilation rate=2), the weight having a kernel size of 2 (i.e., kernel size=2) may be applied once for every two pieces of input data during a computation, that is, at an interval of two data words. In addition, when the dilation rate is 4 (i.e., dilation rate=4), the weight having a kernel size of 2 (i.e., kernel size=2) may be applied once for every four pieces of input data during a computation, that is, at an interval of four data words. For example, a 3×3 kernel having a dilation rate of 2 (i.e., dilation rate=2) may have the same view as a 5×5 kernel while using 9 parameters.

A dilated convolution may be used when a wider range of data is desired to be seen during a convolution computation. The dilation rate may be widely used in a 1D convolution computation of time-series data, and a receptive field may increase using the dilation rate. In a convolutional neural network (CNN), the ‘receptive field’ may indicate how many time steps of a previous layer are seen in determining one time step of a current layer, that is, a portion of an input image being seen by a certain convolutional neuron. Each neuron of the convolutional layer may be connected to a small field of the input image, and the convolutional layer may include multiple filters (kernels). Each filter may be connected to a certain portion of the input image, and the filter portion connected to the certain portion of the input image may correspond to the receptive field of the filter. The larger the receptive field, the better the prediction accuracy of a neural network model.

As described above, using the dilation rate, the next node may be determined using a further time step compared to a basic 1D convolution computation, and accordingly, the receptive field may increase.

As shown in FIG. 7A, when performing a dilated convolution computation, an AI accelerator may add zeros (“0”), for example, by as much as (dilation rate −1) between each column in a kernel, and accordingly, the size of the kernel may increase by (dilation rate −1) times. When the dilated convolution computation is performed while including zeros (“0”), the amount of computation of the AI accelerator may increase by (dilation rate −1) times, which may increase the computation time.

When the AI accelerator removes a zero-computation involving “0” and performs only a non-zero computation, the AI accelerator may perform the dilated convolution computation with the same number of MAC computations as the 1D convolution computation. Hereinafter, a method of performing a 1D convolution computation while removing zeros (“0”) is described.

When the dilation rate is 2 (i.e., dilation rate=2), a first computation may use pieces of input data DIN0 and DIN2 and a second computation may use pieces of input data DIN1 and DIN3. A third computation may use pieces of input data DIN2 and DIN4, and a fourth computation may use pieces of input data DIN3 and DIN5. The AI accelerator may perform the dilated convolution computation by dividing input data into two sub-blocks of even-numbered data and odd-numbered data and alternately performing the convolution computation on the two sub-blocks.

The AI accelerator may perform the dilated convolution computation by dividing the input data into even-numbered data and odd-numbered data and alternately performing the convolution computation on the two input data sets.

In the same way, when the dilation rate is 3 (i.e., dilation rate=3), the AI accelerator may divide the input data set into three sub-datasets and sequentially perform the convolution computation on the three sub-datasets.

FIG. 7B is a diagram illustrating a memory data alignment state before and after executing a VP_CONV1D_ALIGN command, according to an embodiment. FIG. 7B illustrates a diagram showing a method in which a data aligner processes data when a dilation rate is 2 (i.e., dilation rate=2) and input data c_in is 96 (i.e., input data c_in=96), according to an embodiment.

When the dilation rate is 2 (i.e., dilation rate=2), as shown in FIG. 7B, the AI accelerator may partition input data stored in a source memory into two sub-blocks (e.g., Sub-block0 and Sub-block1) to correspond to the dilation rate and then the data aligner may store the partitioned data in a result memory. The process in which the data aligner aligns data to generate the sub-block Sub-block0 is described below with reference to FIG. 7C. In addition, the process in which the data aligner aligns data to generate the sub-block Sub-block1 is described below with reference to FIG. 7D.

FIG. 7C is a diagram illustrating a process in which a data aligner aligns data to generate a sub-block sub-block0, according to an embodiment.

In step 1, the data aligner may read 96 pieces of data D0[95:0] and store the 96 pieces of data D0[95:0] in an input register DIO_Reg1.

In step 2, the data aligner may store, in an output register DO0_Reg, a mask to store the 96 pieces of data D0[95:0] and masked D0 and may store mask data (e.g., FF, . . . , FFF) to control a memory write operation in a mask register MMask_Reg. At the same time, the data aligner may store D2 data D2[63:0] to be processed in the next step in the input register DI0_Reg1.

In step 3, the data aligner may store the 96 pieces of data D0[95:0] in step 2 and may extract the remaining pieces of D2 data D2[63:0] in a word size of 32. Here, the D2 data D2[63:0] may be stored in a memory. The data aligner may shift the D2 data D2[63:0] by 32 words to the left by a shifter and may store the masked data in the output register DO0_Reg. In addition, the data aligner may store, in the mask register MMask_Reg, the mask data (e.g., FF, . . . , FFF) to be used as a write enable signal of the memory when storing the D2 data D2[63:0].

In step 4, the data aligner may shift the D2 data D2[63:32] to the right by 96 words to store the remaining pieces of D2 data D2[63:32] that are processed in step 3 in a first word area of 32 word areas of the memory and may store the result obtained by passing through masking by the mask data (e.g., FF, . . . , FFF) in the output register DO0_Reg. In addition, the data aligner may store the D2 data D2[95:64] in the input register DI0_Reg1 for the next processing.

In step 5, the data aligner may store, using the left shift function, the D2 data D2[95:64] in the output register DOO_Reg by aligning the D2 data D2[95:64] with the memory position where the D2 data D2[95:64] is to be stored. The data aligner may read D4 data D4[95:0] and store the D4 data D4[95:0] in the input register DI0_Reg1 for the next processing.

In step 6, the data aligner may perform the same data processing on the D4 data D4[95:0] as in step 2.

FIG. 7D is a diagram illustrating an operation of a data aligner in a process in which a data aligner generates a sub-block sub-block1, according to an embodiment.

The data aligner may process pieces of data in order of D1, D3, and D5, for example.

In step 1, the data aligner may read D1 data D1[31:0].

In step 2, the data aligner may shift the D1 data D1[31:0] to the right and align the D1 data D1[31:0] in a first word space of 32 word areas of a memory, perform masking on the D1 data D1[31:0] with the second mask data DMask, and store the D1 data D1[31:0] in the output register DO0_Reg. In addition, the data aligner may read D1 data D1[95:32] to be processed in the next step and store the D1 data D1[95:32] in the input register DI0_Reg1.

In step 3, the data aligner may shift the D1 data D1[95:32] to the left and align the D1 data D1[95:32]. In addition, the data aligner may read D3 data D3[95:0] and store the D3 data D3[95:0] in the input register DI0_Reg1.

In step 4, the data aligner may place D3 data D3[31:0] on the left side of a word space of 128 and store the D3 data D3[31:0] in the output register DOO_Reg.

In step 5, the data aligner may place the remaining pieces of data D3[95:32] of the D3 data D3[31:0] on the right side of the word space of 128 and store the remaining pieces of data D3[95:32] in the output register DOO_Reg. At the same time, the data aligner may read D5 data D5[31:0] from the memory and store the D5 data D5[31:0] in the input register DI0_Reg1.

In step 6, the data aligner aligns the D5 data D5[31:0], and this process may be performed in the same way as the process of processing the D1 data D1[31:0] in step 2.

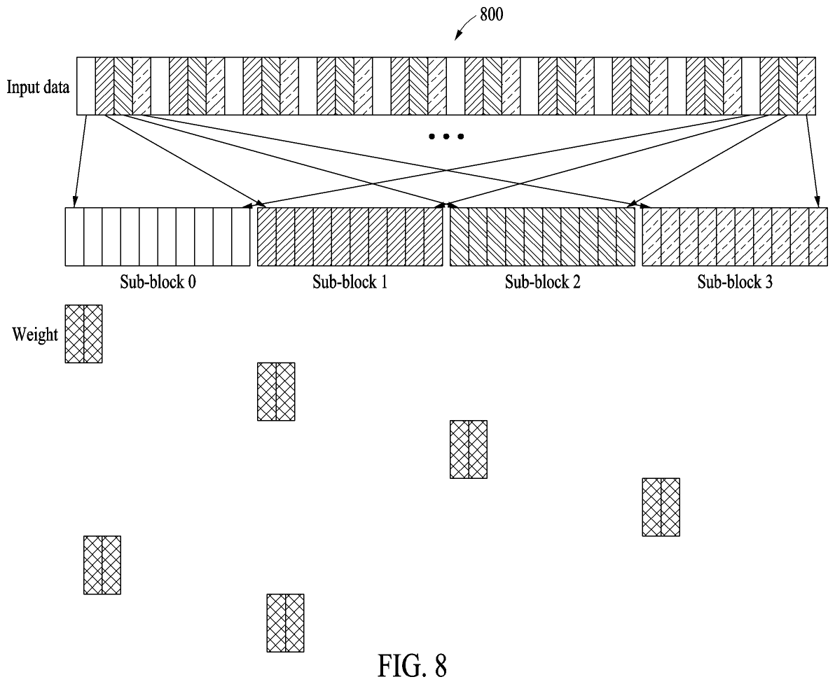

In the same way as described above for the case in which the dilation rate is 2 (i.e., dilation rate=2), when the dilation rate is 4 (i.e., dilation rate=4), the data aligner may divide the input data into four sub-blocks and perform a convolution computation on the four sub-blocks sequentially. How the input data is divided into the four sub-blocks when the dilation rate is 4 (i.e., dilation rate=4) and how the sub-blocks are accessed when the convolution computation is performed are described in more detail below with reference to FIG. 8.

FIG. 8 is a diagram illustrating a method in which an AI accelerator performs a dilated convolution computation, according to an embodiment.

According to an embodiment, FIG. 8 illustrates a diagram 800 showing a method in which an AI accelerator (e.g., the AI accelerator 200) divides input data into four sub-blocks (Sub-block 0, Sub-block 1, Sub-block 2, and Sub-block 3) and performs a convolution computation by accessing the four sub-blocks when a dilation rate is 4 (i.e., dilation rate=4) and a kernel size is 2 (i.e., kernel size=2). Here, the kernel size may determine the view of a convolution.

The method in which the AI accelerator may use hardware for an existing 1D convolution computation while reducing the computation time by removing zeros (“0”) may be as follows.

When the dilation rate is 4 (i.e., dilation rate=4), as shown in FIG. 8, the AI accelerator may divide the input data into the four sub-blocks (Sub-block0, Sub-block1, Sub-block2, and Sub-block3) and sequentially perform a convolution computation on the four sub-blocks. The AI accelerator may partition the input data into the number of sub-blocks corresponding to the number of dilation rates.

The AI accelerator may partition (or rearrange) the input data into the sub-blocks using a VP_CONV1D_ALIGN command to perform a dilated convolution computation using the method described above and may store the partitioned sub-blocks in the data buffers 314.

When the command register CMD_Reg 311 of the AI accelerator receives the VP_CONV1D_ALIGN command, the VPC controller VPC_CTRL 313 may generate a control signal and control the data aligner 317. The substantial rearrangement may be performed by the data aligner 317.

The AI accelerator may perform the 1D convolution computation on the sub-blocks stored in the data buffers 314 by executing the VP_CONV1D command. The AI accelerator may sequentially access the input data that is divided into the sub-blocks and may perform a convolution computation. The VPC controller VPC_CTRL 313 may control the address controller Addr_Ctrl 312, sequentially generate addresses for the sub-blocks to be accessed, and cause the sub-blocks to be accessed sequentially.

The address controller Addr_Ctrl 312 may generate addresses of the data buffers 314 according to a control signal of the VPC controller VPC_CTRL 313. Since only the time required to access the input data at one time is required to perform the VP_CONV1D_ALIGN command, the AI accelerator may achieve greater computational efficiency as the dilation rate value increases.

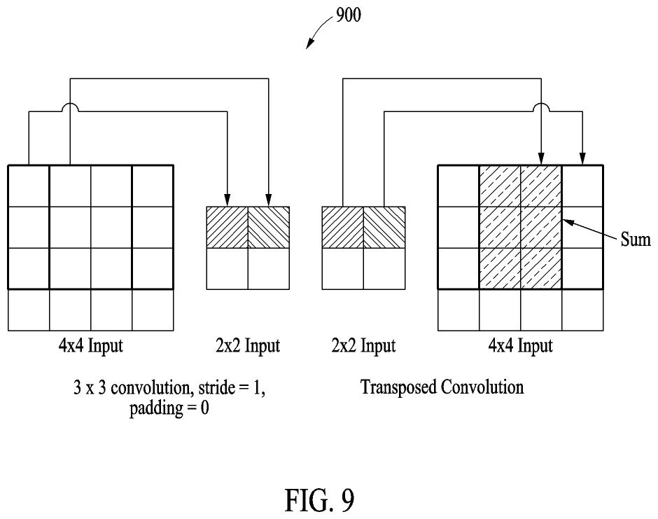

FIG. 9 is a diagram illustrating a concept of a transposed convolution computation, according to an embodiment. FIG. 9 illustrates a diagram 900 showing a concept of a transposed convolution computation, according to an embodiment.

The transposed convolution computation is a computation that may be performed similarly to the dilated convolution computation described above and may be used to dilate output data. The transposed convolution computation may be used, for example, to generate pulse code modulation (PCM) data in a TTS application.

For example, when using a 3×3 kernel, a general convolution computation illustrated in the left diagram of FIG. 9 may represent a “many-to-one” relationship in which 9 input values are connected to 1 output value of a kernel. In the general convolution computation, when a 3×3 convolution computation is performed on 4×4 input data by using a stride of 1 (i.e., stride=1) and padding of 0 (i.e., padding=0), 2×2 output data may be obtained. The stride may determine the step size of the kernel when traversing an image. The stride may indicate how much kernel to move and apply. The stride may also be referred to as a ‘stride interval.’

Padding may determine how to adjust the edge of a sample (e.g., input data). While a padded convolution maintains the same dimension of the output data as the input data, an unpadded convolution may cut off a portion of the edge when the kernel is greater than 1.

In contrast, the transposed convolution computation illustrated in the right diagram of FIG. 9 may represent a “one-to-many” relationship that changes 1 input value to 9 output values. The transposed convolution computation may be used when the general convolution computation is desired to be performed in reverse. The transposed convolution computation may generate 4×4 output data with respect to 2×2 input data.

Since the transposed convolution computation method described above is not suitable for an AI accelerator that performs an efficient computation through parallel processing, an application program may perform the transposed convolution computation by converting the transposed convolution computation into the general convolution computation to improve the computational efficiency of the transposed convolution computation.

The method of converting the transposed convolution computation with a stride applied to the general convolution computation is known and may be briefly summarized as follows.

“0” by as much as stride—1 may be inserted between pieces of input data and “0” by as much as kernel size—padding may be added on both sides of the pieces of input data. The 1D convolution may be performed after transposing weight data.

In the conversion process described above, it may be seen that zeros are inserted into the pieces of input data when the stride is applied. When it is possible to remove zeros due to the stride while converting the transposed convolution computation into the general convolution computation, the computational efficiency of the transposed convolution computation in the AI accelerator may increase.

In general, in the case of a transposed convolution computation with a stride applied, zeros may be added so that computational efficiency may decrease. Accordingly, the AI accelerator may perform the convolution computation by dividing transposed weight data into pieces of sub-weight data (sub-blocks) to remove zeros, controlling an address of the weight data, and alternately accessing the pieces of sub-weight data.

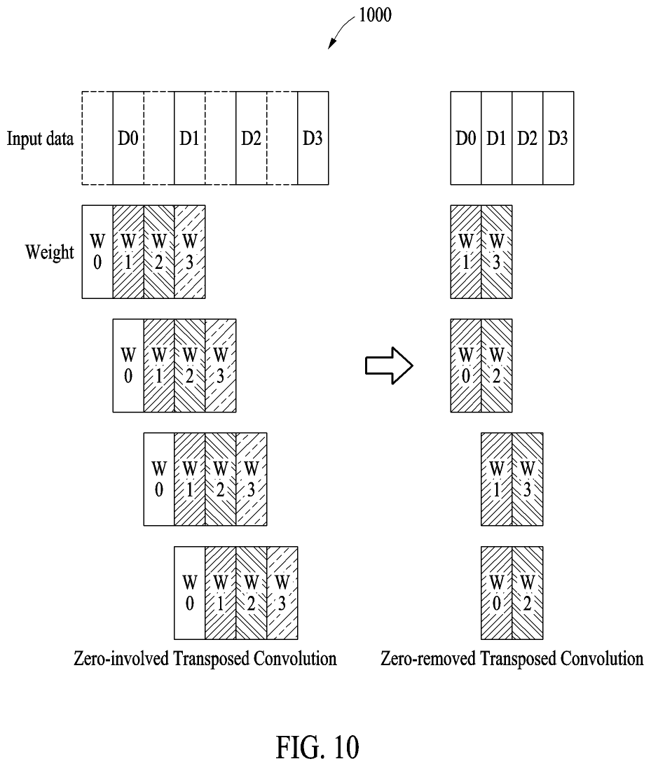

A convolution process before and after zeros are removed is described in more detail below with reference to FIG. 10.

FIG. 10 is a diagram illustrating a method of removing zeros applied due to a stride when converting a transposed convolution computation with the stride applied to a general convolution computation and performing a computation, according to an embodiment. According to an embodiment, FIG. 10 illustrates a diagram 1000 showing a method of converting a transposed convolution computation including zeros into a general convolution computation with zeros removed when a kernel size is 4 (i.e., kernel size=4), a stride is 2 (i.e., stride=2), and padding is 2 (i.e., padding=2).

For example, as shown in the left diagram of FIG. 10, an AI accelerator may rearrange pieces of input data at a stride interval (‘2’) and may add zeros (“0”) to both sides of the pieces of input data. Here, the number of added zeros (“0”) may be, for example, the same as (kernel size (‘4’)−padding (‘2’)=2). That is, the AI accelerator may insert the number of zeros (“0”) by as much as (stride (‘2’)−1) between the pieces of input data. Alternatively, the AI accelerator may add the number of zeros (“0”) by as much as (kernel-size−padding) to both ends of the pieces of input data.

Referring to FIG. 10, similar to the dilated convolution computation, it may be seen that zeros (“0”) are included in the convolution computation. As shown in FIG. 10, to remove zeros (“0”) from the computation, the AI accelerator may rearrange a weight having a kernel size of 4 (i.e., kernel size=4) into two sub-weights having a kernel size of 2 (i.e., kernel size=2).

As shown in the right diagram of FIG. 10, sub-weights W1 and W3 may be used for a first computation and sub-weights W0 and W2 may be used for a second computation. In addition, the sub-weights W1 and W3 may be used for a third computation and the sub-weights W0 and W2 may be used for a fourth computation.

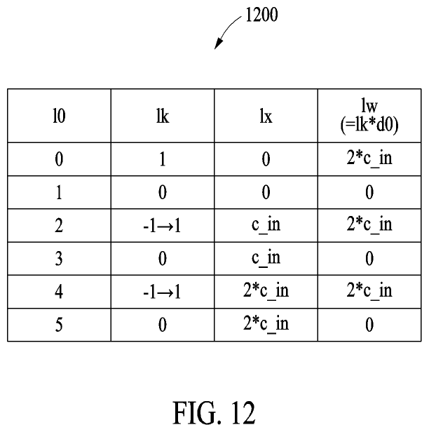

In the case of the transposed convolution computation, when the stride is applied, the AI accelerator must perform the convolution computation by adding zeros (“0”) to the pieces of input data. According to an embodiment, the AI accelerator may perform a non-zero computation by rearranging kernel data (weight data) and assigning an address to the kernel data in the manner described below with reference to FIG. 12, instead of adding zeros (“0”) to data for a non-zero computation without zeros.

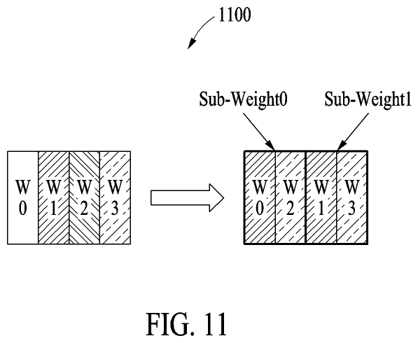

FIG. 11 is a diagram illustrating a method of removing zeros in a transposed convolution computation, according to an embodiment. FIG. 11 illustrates a diagram 1100 showing a method of partitioning and rearranging weight data, according to an embodiment.

For example, an application program, such as TTS or command recognition, may divide one piece of weight data W0, W1, W2, or W3 into two pieces of sub-weight data Sub-Weight0 W0 and W2 and Sub-Weight0 W1 and W3. The application program may store the pieces of weight data in the order of W0, W2, W1, and W3 in the NAND flash memory 306. The AI accelerator may perform a transposed convolution computation by the application program, such as convolution computation TTS from which zeros (“0”) are removed or command recognition, by sequentially accessing the pieces of weight data stored in the NAND flash memory 306 according to the stored order (e.g., W0, W2, W1, and W3) during the convolution computation.

FIG. 12 is a diagram illustrating a method of calculating a lk variable and an address of weight data, according to an embodiment. In FIG. 12, according to an embodiment, a kernel size may be 4 (i.e., kernel size=4), a stride may be 2 (i.e., stride=2), and padding may be 2 (i.e., padding=2).

FIG. 12 illustrates a table 1200 showing a method of calculating the lk variable and the address of the weight data when the initial value of lk is 1 (i.e., initial value of lk=1) and d0 is 2*c_in (i.e., d0=2*c_in), according to an embodiment.

In an embodiment, the weight data may be accessed using variables lk and d0.Here, lk may correspond to a pointer that selects one of two pieces of sub-weight data. d0 may correspond to the length of the sub-weight data. The initial value of lk may be obtained by Equation 1 below.

$$lk = ( Kernel\_size - 1 ) - padding \qquad [ Equation 1 ]$$

In FIG. 12, the initial value of the pointer lk may be 1, and the pointer lk may decrease by 1 after the convolution computation is completed on the C_out pieces of weight data with respect to a corresponding input. Here, an AI accelerator may add the value of a stride when a value of lk becomes smaller than 0.

Through this process, lk may operate as a pointer index of the rearranged weight data. The AI accelerator may convert the pointer lk into a memory address using the length value of the sub-weight data used for the computation.

The AI accelerator may store the length value of the sub-weight data in the d0 variable.

In the example described above, the weight data has a size of kernel_size*c_in, and since only ½ of the weight data is involved in the convolution computation, d0 may be expressed as Equation 2 below.

$$d 0 = kernel\_size * c\_in / 2 = 2 * c\_in \qquad [ Equation 2 ]$$

In this case, the pointer value to access the weight data may be lk*d0, that is, 2*c_in*lk.

The address controller Addr_Ctrl 312 of the AI accelerator may receive related parameters from the VPC controller VPC_CTRL 313 and may generate an address to access the weight data. In general, in the transposed convolution computation, the kernel size kernel_size may be a multiple of the stride due to the data alignment problem.

According to an embodiment, the AI accelerator may use the lk and d0 variables only when the above-described condition (e.g., a condition in which kernel size kernel_size is a multiple of the stride) is satisfied and may perform, through partition and rearrangement of the weight data, a 1D transposed convolution computation with a stride from which zeros (“0”) are removed.

For example, in the above-described situation, it may be assumed that zeros (“0”) are not added to the input data. In this case, padding may be 3 (i.e., padding=3), and the AI accelerator may perform the convolution computation using the lk and d0 variables. The AI accelerator may convert the transposed ID convolution computation into a method of using a general convolution computation by using the lk and d0 variables and rearranging the weight data only when the kernel size kernel_size is a multiple of the stride and “0” is not added to the input data. In this case, the AI accelerator may shorten the calculation time by performing only the non-zero computation.

In the table 1200, I0 may represent a stage in which the transposed 1D convolution proceeds, Ix may represent an address offset value used when accessing a data buffer, and Iw=lk*d0 may represent an address offset value for the sub-weight data used when accessing a weight buffer.

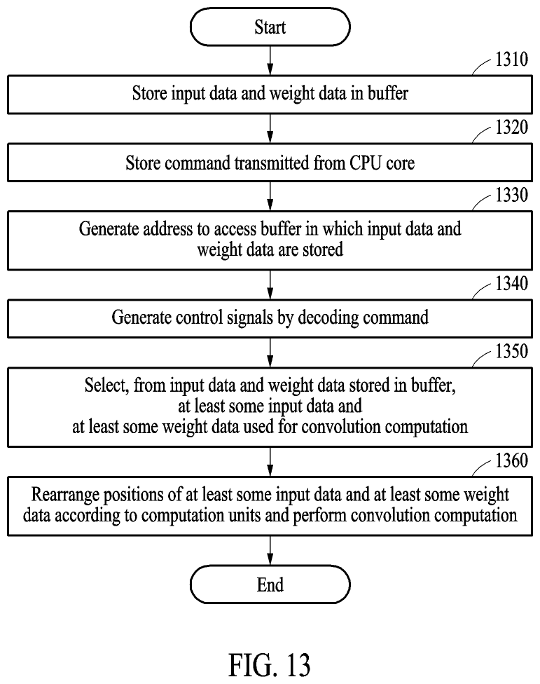

FIG. 13 is a flowchart illustrating an operating method of an AI accelerator, according to an embodiment. Operations to be described hereinafter may be performed sequentially but not necessarily. For example, the order of the operations may be changed and at least two of the operations may be performed in parallel.

Referring to FIG. 13, according to an embodiment, the AI accelerator may perform a convolution computation through operations 1310 to 1360.

In operation 1310, the AI accelerator may store input data and weight data in a buffer. For example, to reduce the time to read data from a NAND flash memory during a computation, a weight storage buffer may use two buffers. When one of the two weight storage buffers is being used for a computation, the AI accelerator may read and store data to be used for the next computation using the other weight storage buffer. Here, the data that is read for the next computation may be stored in an internal memory. When external data is required, the AI accelerator may move the data from a memory (e.g., a CPU memory) to a buffer (e.g., an IX buffer) inside the AI accelerator and then transmit a command.

In operation 1320, the AI accelerator may store a command transmitted from a CPU core. The command may include, for example, at least one of a storage position of the input data, a storage position of the weight data, a type of the convolution computation, a length of data involved in the convolution computation, a stride interval for the convolution computation, and a dilation rate.

In operation 1330, the AI accelerator may generate an address to access the buffer in which the input data and the weight data are stored.

In operation 1340, the AI accelerator may generate control signals by decoding the command stored in operation 1310.

In operation 1350, the AI accelerator may select, from the input data and the weight data stored in the buffer, at least some input data and at least some weight data used for the convolution computation.

In operation 1360, the AI accelerator may rearrange the positions of the at least some input data and the at least some weight data selected from operation 1350 according to computation units and may perform the convolution computation.

For example, when pieces of information included in the command stored in operation 1320 instruct the performance of a dilated convolution computation, the AI accelerator may perform the dilated convolution computation.

The process in which the AI accelerator performs the dilated convolution computation may be as follows.

For example, when the dilation rate among the pieces of information included in the command is greater than a preset value (e.g., the dilation rate>1), the AI accelerator may receive, from the CPU core, a first partition command that partitions the input data into multiple sub-blocks. The AI accelerator may access the input data stored in a data buffer using the storage position of the input data included in the command on the data buffer and length information of the input data. The AI accelerator may rearrange the input data accessed by the dilation rate into the sub-blocks according to the first partition command. The AI accelerator may assign the accessed input data to a corresponding sub-block by a dilation rate value. The

AI accelerator may store, in an output buffer, the input data that is rearranged into the sub-blocks according to position information of the output buffer included in the command. As the rearrangement of the input data into the sub-blocks is terminated, the AI accelerator may sequentially access the rearranged sub-blocks and perform the dilated convolution computation. When the rearrangement of the input data into the sub-blocks is terminated, the CPU core may perform a 1D convolution computation (e.g., a dilated convolution computation) by transmitting a command that performs the 1D convolution computation to the AI accelerator.

In addition, for example, when the pieces of information included in the command stored in operation 1320 instruct the performance of a transposed convolution computation, the AI accelerator may perform the transposed convolution computation. As described above, an application program may convert the transposed convolution computation into a general convolution computation using the following method. The application program may transpose the weight data such that zeros added to the input data according to the stride interval are not included in the computation. The application program may divide the transposed weight data into the sub-blocks (pieces of sub-weight data) to remove zeros and may store the sub-blocks in an external memory. Here, the external memory may be a non-volatile memory, such as a NAND flash memory, for example.

The AI accelerator may read the pre-stored data through the process described above and perform the transposed convolution computation.

The AI accelerator may perform the transposed convolution computation between the transposed weight data that is divided into the sub-blocks and the input data to which zeros are not added (that is, the input data from which zeros to be added at the stride interval are removed). The AI accelerator may access the input data and the weight data that is rearranged into the sub-blocks in a data memory and a weight memory by using the storage position of the input data included in the command on the data buffer, the storage position of the weight data on the weight buffer, and the length information of the data associated with the transposed convolution computation and may perform the transposed convolution computation. The AI accelerator may store the result of the transposed convolution computation in the data memory according to the storage position information provided by the command.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. An artificial intelligence (AI) accelerator comprising:
a vector processing circuit (VPC) configured to, according to commands, perform a rearrangement on input data into sub-blocks, configured to generate addresses for the rearranged sub-blocks, and configured to perform vector processing for a convolution computation.

2. The AI accelerator of claim 1, wherein the commands comprise at least one of a first command to perform the rearrangement on the input data into the sub-blocks and a second command to perform the convolution computation on the rearranged sub-blocks.

3. The AI accelerator of claim 1, wherein the VPC comprises at least one of:
a command register configured to store a command for the vector processing transmitted from a central processing unit (CPU) core;
an address controller configured to generate an address to access a buffer in which the input data and weight data are stored;
a controller configured to generate control signals to control the VPC by decoding the command stored in the command register;
an interconnect exchange (IX) buffer comprising a data buffer that stores the input data and a weight buffer that stores the weight data;
a data aligner configured to select, from the input data and the weight data stored in the IX buffer, at least some input data and at least some weight data used for the convolution computation and configured to rearrange positions of the at least some input data and the at least some weight data according to computation units; and
a vector computation circuit comprising the computation units for real-time processing of a speech signal and configured to perform the convolution computation on the rearranged sub-blocks.

4. The AI accelerator of claim 3, wherein the data aligner comprises at least one of:
to perform the rearrangement on the at least some input data according to a first command or to compute two vector operands according to a second command, a first data aligner configured to perform the rearrangement on the at least some input data corresponding to a first vector operand among the two vector operands; and
to compute the two vector operands according to the second command, a second data aligner configured to perform the rearrangement on at least one of the at least some weight data and the at least some input data, which corresponds to a second vector operand among the two vector operands.

5. The AI accelerator of claim 4, wherein the first data aligner comprises at least one of:
according to the second command that uses the two vector operands, a first input register configured to store second 128-word data among two pieces of 128-word data to rearrange the first vector operand according to inputs of the computation units;
a second input register configured to store 128-word data to rearrange the at least some input data according to the first command, and according to the second command, configured to store first 128-word data among the two pieces of 128-word data to rearrange the first vector operand according to the inputs of the computation units;
for a mask generation, a mask generation circuit configured to generate first mask data used as a write enable write_enable control signal in a word unit with respect to an output memory or second mask data;
a shifter configured to align pieces of data stored in the second input register according to the first command and configured to align pieces of data stored in each of the first input register and the second input register according to the second command;
a masking circuit configured to generate data used for a multiplication and accumulation (MAC) computation through masking between the pieces of data aligned by the shifter and the second mask data and configured to record ‘0’ in a position of data that is not used for the MAC computation; and
a mask register configured to store the first mask data.

6. The AI accelerator of claim 4, wherein the second data aligner comprises:
a first input register and a second input register configured to respectively store two pieces of 128-word data to align the at least some weight data or the at least some input data corresponding to the second vector operand among the two vector operands;
a shifter configured to align pieces of data stored in the first input register and the second input register;
a mask generation circuit configured to generate mask data for a mask generation; and
a masking circuit configured to generate data used for a multiplication and accumulation (MAC) computation by masking the aligned pieces of data by the mask data.

7. The AI accelerator of claim 3, wherein the computation units comprise at least one of:
128 16-bit floating-point multipliers;
128 32-bit floating-point adders to obtain a sum of outputs of the 128 16-bit floating-point multipliers;
an accumulator to obtain an accumulated sum of multiplication and accumulation (MAC) computation results; and
128 rectified linear units (ReLUs) or 128 Leaky ReLUs.

8. The AI accelerator of claim 1, further comprising:
a floating-point calculating circuit configured to perform a high-precision computation used in executing an application program.

9. A system-on-chip (SoC) comprising:
a memory configured to store input data of an artificial neural network model for a convolution computation;
a central processing unit (CPU) core configured to generate commands for the convolution computation;
a negative AND (NAND) controller configured to communicate with an external memory that stores weight data of the artificial neural network model for the convolution computation; and
an artificial intelligence (AI) accelerator configured to perform a rearrangement on the input data, which is obtained from the memory, into sub-blocks according to the commands and configured to perform the convolution computation by generating addresses for the rearranged sub-blocks,
wherein the commands comprise a first command configured to perform the rearrangement on the input data into the sub-blocks and a second command configured to perform the convolution computation on the rearranged sub-blocks.

10. The SoC of claim 9, wherein the memory is configured to further store at least one of information used by the CPU core to generate the commands for the AI accelerator and data to be transmitted to the AI accelerator.

11. The SoC of claim 9, wherein the CPU core is configured to generate and transmit the commands that perform vector processing for the convolution computation performed by the AI accelerator.

12. The SoC of claim 9, wherein the NAND controller is configured to read the weight data stored in the external memory and transmit the weight data to a weight buffer of the AI accelerator.

13. The SoC of claim 9, wherein the external memory comprises a non-volatile memory comprising a NAND flash memory,
wherein the NAND flash memory is connected to the SoC and configured to store at least one of the weight data and an instruction of the artificial neural network model.

14. The SoC of claim 9, wherein the AI accelerator comprises:
according to the first command, a data aligner configured to select, from the input data, at least some input data used for the convolution computation and configured to perform a rearrangement on the selected at least some input data into the sub-blocks; and
a vector computation circuit comprising computation units, and according to the second command, configured to read the rearranged sub-blocks and configured to perform the convolution computation.

15. An electronic device comprising:
a system-on-chip (SoC); and
a negative AND (NAND) flash memory connected to the SoC and configured to store weight data and an instruction of an artificial neural network model,
wherein the SoC comprises:
a memory configured to store input data of the artificial neural network model for a convolution computation;
a central processing unit (CPU) core configured to generate commands for the convolution computation;
a NAND controller configured to communicate with an external memory that stores the weight data of the artificial neural network model for the convolution computation; and
an artificial intelligence (AI) accelerator configured to perform a rearrangement on the input data, which is obtained from the memory, into sub-blocks according to the commands and configured to perform the convolution computation by generating addresses for the rearranged sub-blocks,
wherein the commands comprise a first command configured to perform the rearrangement on the input data into the sub-blocks and a second command configured to perform the convolution computation on the rearranged sub-blocks.

16. An operating method of an artificial intelligence (AI) accelerator, the operating method comprising:
storing input data and weight data in a buffer;
storing a command transmitted from a central processing unit (CPU) core;
generating an address to access the buffer in which the input data and the weight data are stored;
generating control signals by decoding the command;
selecting, from the input data and the weight data stored in the buffer, at least some input data and at least some weight data used for a convolution computation; and
performing the convolution computation by rearranging positions of the selected at least some input data and the selected at least some weight data according to computation units.

17. The operating method of claim 16, wherein the command comprises at least one of a storage position of the input data, a storage position of the weight data, a type of the convolution computation, a length of data involved in the convolution computation, a stride interval for the convolution computation, and a dilation rate.

18. The operating method of claim 16, wherein the performing of the convolution computation comprises:
when pieces of information comprised in the command instruct performance of a dilated convolution computation, performing the dilated convolution computation; and
when the pieces of information comprised in the command instruct performance of a transposed convolution computation, performing the transposed convolution computation.

19. The operating method of claim 18, wherein the performing of the dilated convolution computation comprises:
receiving, from the CPU core, a first partition command configured to partition the input data into multiple sub-blocks when a dilation rate among the pieces of information comprised in the command is greater than a preset value;
accessing the input data in a data buffer using a storage position of the input data comprised in the command on the data buffer and length information of the input data;
performing a rearrangement on the accessed input data into the multiple sub-blocks by the dilation rate according to the first partition command;
according to position information of an output buffer comprised in the command, storing, in the output buffer, the accessed input data that is rearranged into the multiple sub-blocks; and
performing the dilated convolution computation by sequentially accessing the rearranged multiple sub-blocks as the rearrangement of the accessed input data into the multiple sub-blocks is terminated.

20. The operating method of claim 18, wherein the performing of the transposed convolution computation comprises:
transposing the weight data;
dividing the transposed weight data into sub-blocks and storing the divided sub-blocks in an external memory;
performing the transposed convolution computation between the transposed weight data that is divided into the sub-blocks and the input data from which zeros to be added at a stride interval are removed; and
storing a result of the transposed convolution computation in a data memory according to storage position information provided by the command.
